(19) United States
(12) Patent Application Publication
(10) Pub. No.: US 2004/0048222 A1
(43) Pub. Date: Mar. 11, 2004

(54) Compound palatinal arch for correcting tooth positions

(76) Inventors: Rolf Forster, Vogesenallee (DE); Franz Gunter Sander, Ulm (DE)

Correspondence Address: LADAS & PARRY, 224 SOUTH MICHIGAN AVENUE, SUITE 1200, CHICAGO, IL, 60604, US

(21) Appl. No.: 10/363,978

(22) PCT Filed: Sep. 6, 2001
(86) PCT No.: PCT/EP01/10240

(30) Foreign Application Priority Data
Sep. 7, 2000 (DE) 100458025

(51) Int. Cl. A61C 3/00

(52) U.S. Cl. 433/7

(57) ABSTRACT

The invention describes a composite palatal arch for the correction of the position of teeth, which is built up from a plurality of wire sections (1, 2, 3, 4, 5) made from different materials. One of the materials is a shape-memory alloy that assumes a superelastic state at the temperatures prevailing in a human mouth. The palatal arch comprises two end sections (2, 3), which are intended to fix the palatal arch in a tooth lock (16, 17) and which are made from of a normal-elastic material. The superelastic section (4, 5) of the arch is softer than are the normal-elastic sections (1, 2, 3). The superelastic material is present only in two intermediate sections (4, 5) between the two end sections (2, 3) and a central section (1), the two intermediate sections (4, 5) are each arranged adjacent one of the end sections (2, 3), and the central section (1) of the palatal arch consists of a normal-elastic material.

1. Field of the Invention

The present invention relates to a palatal arch for the correction of the position of teeth,

built up from a plurality of wire sections made from different materials, one of which materials is a shape-memory alloy that assumes a superelastic state at the temperatures prevailing in a human mouth,

and comprising two end sections, which are intended to fix the palatal arch in a tooth lock and which are made from of a normal-elastic material,

the section assuming a superelastic state being softer than the sections made from a normal-elastic material.

2. Description of Related Art

A palatal arch of that kind is known from U.S. Pat. No. 5,312,247 A. It consists of a wire with a central section made from a superelastic shape-memory alloy based on nickel and titanium and two end sections made from steel. It serves as a tensioning element between two teeth in the upper jaw, especially a molar on the right side of the upper jaw and a molar on the left side of the upper jaw. For fixing the palatal arch on the molars, one attaches to the latter a tooth lock which, when fitted on the molars, is also known as molar lock and, when located on the side of the tooth facing the tongue, is also described as lingual lock. Usually, the tooth lock consists of a small tube or a similar holder, which is fixed by welding to a metal strip that encloses the tooth and in which the respective end sections of the palatal arch can be fitted.

In order to correct misalignments of the teeth, the palatal arch is activated, i.e.

preformed and fitted, in such a manner that after attachment to the two teeth it will remain under mechanical stress. That stress is then gradually released as correction of the tooth position progresses. The direction in which the tooth position is corrected is determined by the shape of the palatal arch and its biasing direction. Apart from U.S. Pat. No. 5,312,247 A, palatal arches have become known through publications by Korkhaus, Graber, Goshgarian, Rohit, Sachdeva as well as Wendell and Behrendt.

In the case of the palatal arch known from U.S. Pat. No. 5,312,247 A, the largest part of its length is taken by the superelastic central section which serves the purpose to keep the force, which eventually causes the tooth position to be corrected, at a uniform and relatively low level, in spite of the progressing correction process. In fact, this is however not really achieved by the structure of the palatal arch disclosed in U.S. Pat. No. 5,312,247 A. For, in order to reach the martensite plateau, characteristic of the superelastic behaviour on the curve describing the elastic behaviour of the palatal arch, the palatal arch would have to be deformed in the biasing process to an extent greater than that achievable by an orthodontist under the given conditions. As a result, in stead of occurring on the martensite plateau, correction of the tooth position occurs with the known palatal arch essentially over the rising initial section of the curve describing the elastic behaviour, where the increasing extension requires a considerably increasing force to be applied, so that as the palatal arch loses tension in the course of the tooth-position correction process the correcting force tends to zero at a correspondingly steep angle.

US 00Re35,170 E discloses another palatal arch comprising a central portion made from a nickel-titanium alloy with shape-memory properties, and end sections made from steel. However, the shape-memory alloy used in this case has a martensite-to-austenite transformation temperature lower than the temperature prevailing in the mouth. This means that when fitted in the mouth, the palatal arch is not superelastic because it cannot reach the martensite plateau under these conditions. Instead, US 000 Re35,170 E teaches to bring the palatal arch in its austenitic state into exactly the shape which it is to reach at the end of the tooth-position correction process. Thereafter, back in the martensitic state, the palatal arch is elastically deformed to the shape that corresponds to the position of the teeth before commencement of the correction process so as to permit easy and stress-free fitting of the palatal arch on the teeth. The higher temperature in the mouth then causes the palatal arch to assume its austenitic state in which it tends to return to the shape given to it in the martensitic state (memory effect). The palatal arch thereby exerts on the teeth, on which it is fitted, forces or moments which automatically disappear when the shape impressed to it in the martensitic state is reached. Consequently, the force applied during the tooth-position correction process is again not a uniform force, but rather one that steeply drops from a peak value to zero, which means that on the one hand the peak value may cause overstressing while on the other hand the progress of the correction process is progressively retarded. This is undesirable.

### SUMMARY OF THE INVENTION

Now, it is the object of the present invention to open up a possibility of having a palatal arch actually exert an approximately uniform correction force that brings the tooth-position correction process to a quicker end without overstressing the teeth and the jaw.

This object is achieved by a palatal arch for the correction of the position of teeth,

built up from a plurality of wire sections made from different materials, one of which materials is a shape-memory alloy that assumes a superelastic state at the temperatures prevailing in a human mouth,

and comprising two end sections, which are intended to fix the palatal arch in a tooth lock and which are made from of a normal-elastic material,

the section assuming a superelastic state being softer than the sections made from a normal-elastic material, in which

the superelastic material is present only in two intermediate sections between the two end sections and a central section,

the two intermediate sections are each arranged adjacent one of the end sections,

and in which the central section of the composite palatal arch consists of a normal-elastic material.

The above object is also achieved by a palatal arch for the correction of the position of teeth,

built up from a plurality of wire sections made from different materials, one of which materials is a shape-memory alloy that assumes a superelastic state at the temperatures prevailing in a human mouth,

and comprising two end sections, which are intended to fix the palatal arch in a tooth lock and which are made from of a normal-elastic material,

the section assuming a superelastic state being softer than the sections made from a normal elastic material, in which

the superelastic material is present only in a single intermediate section between one of the end sections and a central section,

said intermediate section is arranged adjacent the respective end section, and in which the central section of the composite palatal arch consists of a normal-elastic material.

Advantageous further developments of the invention are the subject-matter of the sub-claims.

Contrary to the prior art, instead of having the superelastic material located in the central section, the palatal arch has the superelastic material located in two intermediate sections between its two end sections and the central wire section which latter consists of a normal-elastic material in the configuration according to the invention. This novel combination of features results in considerable advantages:

Compared with the prior art, the length of the palatal arch that consists of a superelastic material is reduced, while the length of the palatal arch that consists of a normal-elastic material is increased. During activation, the superelastic intermediate sections reach the martensite plateau of the elastic characteristic already after less deformation as compared with a known comparable palatal bar as described in U.S. Pat. No. 5,312,247, because deformation substantially occurs only in the softer superelastic section. According to the invention, the superelastic intermediate sections of the palatal arch can be brought a good way onto the martensite plateau during activation so that the tooth-position correction process can essentially take place on the martensite plateau.

By having a superelastic material arranged in the intermediate sections between the end sections and the central section, rather than in the central section as such, the force is applied to the teeth that are to be corrected much more directly than in the case of the prior art so that the amount of force and, which is very important, the direction of the force can be adjusted and predetermined in a much more targeted fashion. It is then possible, by giving the palatal arch a corresponding shape, to rotate or displace, or tilt the tooth, on which the arch is anchored, in the desired way or even to realise a combination of such possibilities.

By corresponding selection of the superelastic material and the thickness of the superelastic wire sections, it is possible to purposefully determine the optimum correction force so that it will be just low enough to ensure that the teeth and the jaw will not be overstressed and that it will not be felt as uncomfortable by the patient, and just high enough to ensure that correction of the position of the teeth will be effected much more quickly than with the systems of the prior art.

The solution defined in independent claim 2 differs from the solution of claim 1 in that a single superelastic section is provided in the palatal arch between one of the two end sections and the central, normal-elastic section which latter is immediately followed by the other end section of the palatal arch in this variant of the invention. Such a palatal arch especially allows to have forces and moments act asymmetrically on the two teeth that are to be braced together by the palatal arch, and to properly allow for differently heavy misalignments of the two teeth. Otherwise, the palatal arch according to claim 2 offers the same advantages as the palatal arch according to claim 1. The active force for the tooth-position correction process is defined in the activation step by deformation of the superelastic intermediate section, which latter is so short that the martensite plateau will be easily reached when the palatal arch is fitted on the jaw. The force is produced in the immediate neighbourhood of the tooth whose position is to be corrected and is transmitted to the tooth to be corrected via the normal-elastic end section which, compared with the superelastic intermediate section, is harder and comparatively rigid.

Activation of the palatal arch can be effected in the known manner, namely by varying the spacing between the end sections and their orientation so as to adjust them to their particular correction task, which is achieved by deforming the normal-elastic sections of the palatal arch. This results in a certain biasing effect for the palatal arch, when the latter is mounted on the teeth, and in tensile forces, pressure forces, torques and/or overturning moments being exerted on the teeth that are braced together. According to the invention, such variation of the mutual spacing and orientation of the end sections of the palatal arch, by plastic deformation of normal-elastic wire sections, has the effect that when the palatal arch is fitted on the jaw, the superelastic wire sections are deformed to such a degree that thereafter they will be a good way on their martensite plateau. That this possibility is provided by plastic deformation of the normal-elastic sections is an important aspect because a corresponding plastic deformation of a superelastic section, that would produce the same effect, is extraordinary difficult to achieve in view of the superelastic properties and would not be achievable in an orthodontist's practice.

The length of the superelastic intermediate sections cannot be reduced at desire, for when such length is too short then the degree of correction those sections can produce on the martensite plateau without reactivation would be excessively small so that frequent reactivation by deformation of one of the normal-elastic sections of the palatal arch would be required. On the other hand, the superelastic intermediate section should be kept short enough to ensure that only moderate deformation of the palatal arch, that does not basically modify its shape, will in any case result in a degree of deformation of the superelastic intermediate section high enough to bring it the longest possible way onto the martensite plateau.

It is preferred for this purpose to make the respective superelastic intermediate section shorter than the normal-elastic central section. According to claim 1, it is preferred that the two superelastic intermediate sections together should be shorter than the normal-elastic central section.

A suitable length of the superelastic section has been found to be 3 mm to 15 mm, preferably 5 mm to 12 mm, measuring the developed flexible length.

The superelastic section may especially consist of a spring shaped as a U. It is then possible to produce tensile forces and corresponding torques by extending the U, pressure forces and corresponding torques by compressing the U, and turnover moments by deflecting the legs of the U from their common plane. The term “spring” as used herein is meant to describe a resilient wire which is not straight in its flexible section in its released state. The superelastic wire section may also be constituted by a differently shaped spring, for example a meander-shaped or S-shaped or zigzag-shaped spring.

In order to permit the palatal arch to be activated and, if necessary, to be reactivated after one correction step, its central section is conveniently configured as s shaped wire. The term “shaped wire” as used in this connection is meant to describe a wire which is not straight in its flexible section in the released condition. Preferably, the shaped wire comprises an activation bow, especially an activation bow in the form of a U. By expanding or compressing that bow, which can be effected by means of pliers, the palatal arch can be easily activated or reactivated by the treating orthodontist. Instead of using one or more activation bow, it is also possible to use one or more activation loops, as known for example from the configuration of conventional palatal arches known under the name of Quad-Helix. The normal-elastic central wire section may also consist of a shaped wire of different form, for example of meander, S or zigzag shape. Such configurations also provide the possibility to activate and reactivate the palatal arch, adapt it to the progress of the correction process or vary the extent or direction of the tooth-position correction process by modifying the form of the shaped wire with the aid of pliers.

The normal-elastic wire sections may conveniently consist of stainless steel, especially springy stainless steel, for example steel covered by material No. 1.4310. The normal-elastic wire sections may conveniently consist of one and the same material, although basically they may also consist of different normal-elastic materials.

Springy stainless steel materials do not easily combine with nickel-titanium materials. It is, therefore, preferred to connect the different wire sections of the palatal arch by means of ferrules (crimp barrels). Such ferrules allow one end of a superelastic wire section and one end of a normal-elastic wire section to be introduced into the ferrule either in the same direction or in opposite directions, and to be connected by crimping. Another possibility consists in providing ferrules made from a material that welds or solders well, especially from a stainless steel material, only on the ends of each superelastic wire section, and to connect the ends of the normal-elastic wire sections with the outside of such ferrules by welding or soldering, especially by laser welding.

In addition to varying the effective length of the palatal arch by deforming its central normal-elastic section, it is also possible, according to an advantageous further development of the invention, to achieve such variation by subdividing the central wire section into two portions which are connected one to the other by means of an expansion screw or an expansion appliance through which the distance of the two parts can be varied. Expansion screws or expansion appliances suited for this purpose are known to the man skilled in the art in connection with the correction of misalignments of teeth. Examples of suitable expansion screws are described in DE 824 832 and EP 0 817 596 B1. Expansion screws consist of two bodies which can be varied with respect to their distance by means of a spindle comprising an activation portion and one or two threaded sections extending therefrom. The activation portion is rotatably seated in one body, whereas one threaded portion is rotatably seated in the other body. Both bodies are engaged by straight guide means, for example cylindrical pins, that act as straight guides and prevent any relative movement of the two bodies as their distance is varied. The variation of the distance as such is achieved by rotating the spindle. The spindle may directly engage a thread of the respective body so that any rotation of the spindle will be directly translated into variation of the distance between the two bodies. Instead of having the spindle act directly on the two bodies of the expansion screw, there is, however, also the possibility to have it act indirectly on the two bodies via springs. One then speaks of a spring-operated expansion screw. In this case, a threaded sleeve may be arranged on each of the threaded sections of the spindle, which is guided in a recess of the respective body in lengthwise direction of the spindle and is secured from rotation and which transmits its displacement to the bodies via the spring that finally determines the expansion force, as disclosed in EP 0 817 596 B1. In order to keep the expansion force constant, in spite of the progressing tooth-position correction process, the spring is, preferably, superelastic.

Suitable expansion appliances are disclosed in DE 198 44 616 A1. Expansion appliances likewise comprise two bodies that are connected by straight guide means, especially cylindrical pins, and whose distance can be varied. However, the distance is not varied using a screw or a spindle, but rather by means of removable spacers arranged between the bodies and one or more springs which, preferably, are selected to be superelastic for the reason mentioned before.

The use of an expansion screw or an expansion appliance in the palatal arch provides the advantage that the extent of correction of the tooth position, that can be reached without any reactivation of the palatal arch, is considerably greater and that the activation and the reactivation processes are rendered much easier because there is no need in this case to deform the normal-elastic section of the palatal arch in order to vary the latters effective length. Instead, such variation can be achieved by adjusting the expansion screw or the expansion appliance. This is of advantage also for the patient because he/she is then required to visit the orthodontist less frequently as correction of the tooth position proceeds more rapidly and the risk of the teeth involved being overstressed is further reduced.

A superelastic alloy especially well-suited for this purpose is a shape-memory alloy based on nickel and titanium, which contains nickel and titanium in approximately equal atomic percentages. Such alloys can assume either an austenitic or a martensitic state, depending of the selected temperature. At lower temperatures, the state of martensite is assumed, at higher temperatures that of austenite. The temperature at which the alloy starts its transformation from austenite to martensite during the cooling-down process is known as the Ms point. In the martensitic state below the Ms point such alloys may have shape-memory properties: Plastic deformation, that has taken place in the martensitic state, can be reversed by heating the material up to temperatures above the Ms point. In a temperature range immediately following the Ms point in upward direction, such a shape-memory alloy may show superelastic behaviour. The superelastic behaviour is characterised by the fact that at the beginning the force required for achieving progressive expansion increases clearly, as would be expected of an austenite, but once an expansion of approximately 1% to 2% has been reached, it continues to rise only slightly as expansion proceeds, and resumes its steeply rising curve only after a considerable expansion of 6% to 8% has been reached. The medium expansion range is described as the “martensite plateau”. This terms is derived from the fact that martensite is formed in the alloy under the effect of the tensile force. Once the tensile force is released, the material returns to its austenitic state. Such expansion is highly reversible, i.e. up to an expansion of over 6% to 8%, and is therefore known as superelastic expansion. Due to the pronounced martensite plateau, such superelasticity does not follow Hooke's Law and is, therefore, also described as pseudo-elasticity.

### BRIEF DESCRIPTION OF THE DRAWINGS

Some embodiments of the invention are illustrated in the attached drawings where identical or corresponding parts are designated by the same reference numerals in the different exemplary embodiments. In the drawings:

FIG. 1 shows a top view of a first embodiment of a palatal arch according to the invention;

FIG. 2 shows a detail of a ferrule by means of which the different wire sections of the palatal arch can be firmly connected one with the other;

FIG. 3 shows a detail of another way of connecting a superelastic intermediate section with a normal-elastic wire section, mounted on two molars;

FIG. 4 shows a top view of a second embodiment of a palatal arch according to the invention;

FIG. 5 shows the palatal arch of FIG. 1, mounted on two molars that are braced together in this way;

FIG. 6 shows a third embodiment of a palatal arch, mounted on two molars that are braced together in this way;

FIG. 7 shows a fourth embodiment of a palatal arch, mounted on two molars that are braced together in this way;

FIG. 8 shows a fifth embodiment of a palatal arch, mounted on two molars that are braced together in this way;

FIG. 9 shows a sixth embodiment of a palatal arch with integrated expansion screw; and

FIG. 10 shows a typical tensile stress-strain curve for a superelastic wire.

### DETAILED DESCRIPTION OF THE INVENTION

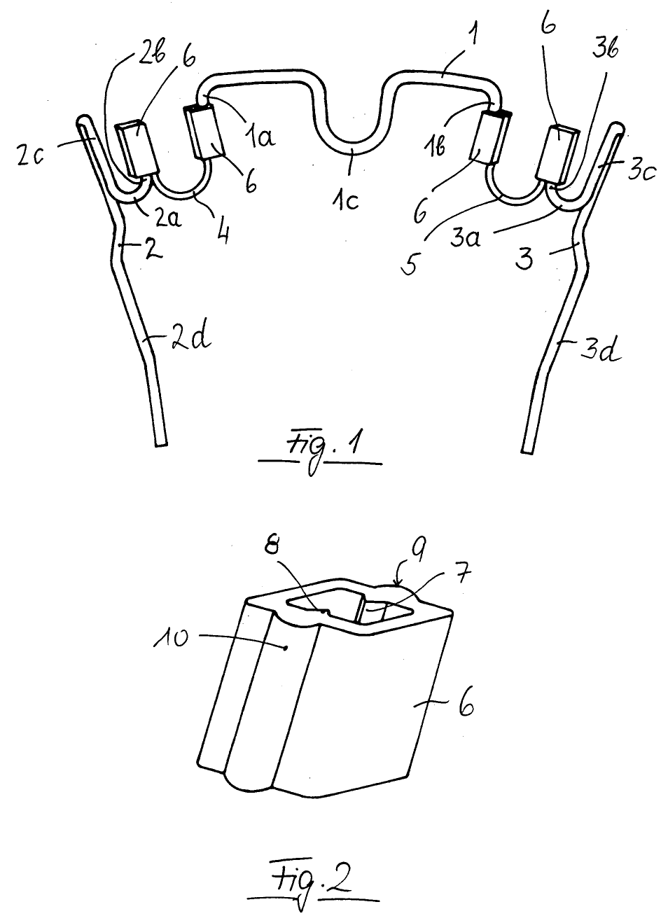

The palatal arch illustrated in FIG. 1 comprises a central section 1, made from stainless steel, and two end sections 2 and 3, made from stainless steel, as well as two intermediate sections 4 and 5, made from a nickel-titanium shape-memory alloy, which contains nickel and titanium in approximately equal atomic percentages and which is pre-treated so as to make it superelastic under the temperatures prevailing in the mouth. Wires having a rectangular cross-section of 0.46 mm×0,64 mm are particularly well-suited for the superelastic intermediate sections 4 and 5. Preferably, the superelastic intermediate sections 4 and 5 have an effective length of 5 mm to 10 mm. This length is advantageous not only for the before-mentioned cross-section, but also for other, differing cross-sections and for larger or smaller cross-sections. The effective length of the superelastic intermediate section 4 or 5, respectively, is understood to be the flexible section, i.e. excluding the ends that are connected with the normal-elastic wire sections, which are clamped together in a ferrule, for example. A material particularly well-suited for the normal-elastic sections 1, 2 and 3 is a round wire made from springy material No. 1.4310 with a diameter of 0.90 mm.

The superelastic intermediate sections 4 and 5 exhibit the shape of a U. The central section 1 has the form of a bracket with two end sections 1a and 1b bent off at approximately right angles, and with a U-shaped activation bow at its centre. The end sections 2 and 3 of the palatal arch each consist of a U-shaped bow 2a, 3a with a shorter leg 2b, 3b and a longer leg 2c, 3c which is given a double-ply design by folding part of the leg back by 180°, the portion 2d, 3d of the leg, which is folded back by 180°, extending beyond the base of the U-shaped bow 2a, 3a by an extension 2d, 3d.

The legs of the superelastic intermediate sections 4 and 5 and the bent-off ends 1a and 1b of the central wire section, and the shorter legs 2b and 3b of the normal-elastic end sections 2 and 3, respectively, are fitted in pairs in ferrules 6, which are squeezed together to firmly connect those elements in pairs. FIG. 2 shows a greatly enlarged view of such ferrules 6. They consist of a substantially rectangular hollow profile with two wedge-type cutting edges 7 and 8, which extend along two oppositely arranged inner surfaces and which are backed by ribs 9 and 10 that likewise extend in lengthwise direction on the outside of the ferrule 6 so that a reliable crimping connection is guaranteed. A material well-suited for the ferrule 6 is stainless steel, material No. 1.4305.

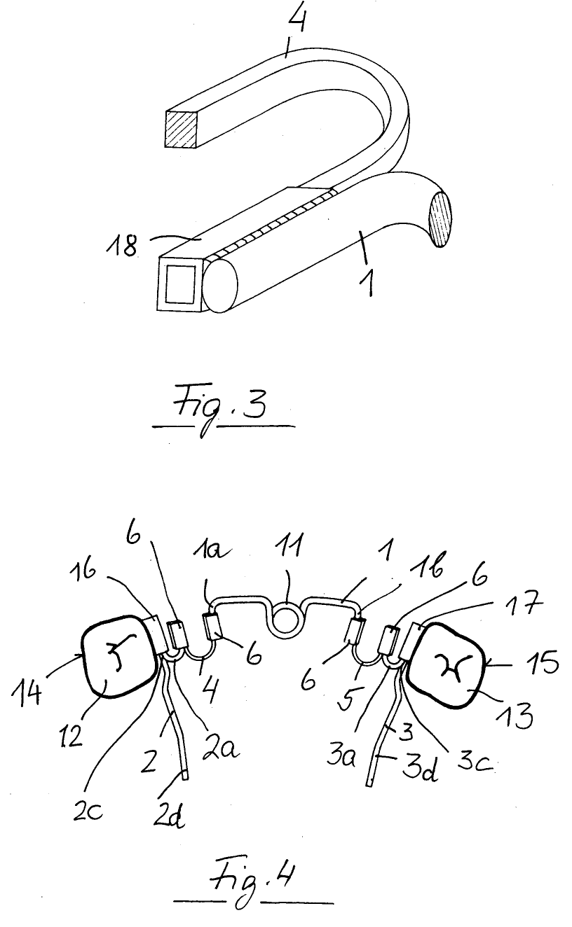

FIG. 3 shows another way of connecting a superelastic wire section, for example the intermediate section 4, with a normal-elastic wire section, for example the central section 1. In this case, a ferrule 18 of rectangular cross-section is used, and the end of the intermediate section 4 is fitted in the ferrule 18, whereafter the latter is crimped so that the ferrule 18 is permanently fixed on the intermediate section 4. The ferrule 18 is made from a normal-elastic stainless steel, especially stainless steel No. 1.4305, so that it can be connected without difficulty with the normal-elastic central section 1 by welding, for example by laser welding. The end of the central wire section 1 is then welded onto one of the outer surfaces of the ferrule 18.

FIG. 4 shows a palatal arch in one possible installed condition in which it braces together two molars 12 and 13. The two molars 12 and 13 are each enclosed by a stainless-steel strip 14, 15, with a tooth lock 16, 17 welded to that side of the tooth that faces the patient's tongue; such a lock is also known as lingual lock because it is used on the lingual side of the tooth, or else as molar lock, because it is used on molars. The double legs 2c and 3c of the end sections 2 and 3, respectively, of the palatal arch are engaged and fixed in the molar locks 16 and 17, and there is further the possibility—as known as such—to use the extensions 2d and 3d to additionally anchor the arch on neighbouring molars if these are likewise equipped with lingual locks. If no additional anchoring is effected, the orthodontist will cut off the superfluous extensions 2d, 3d. Due to the fact that the palatal arch is fixed in the molar locks 16 and 17, the superelastic intermediate sections 4, 5 will assume a different curvature than in the released state. As a result of the biasing force exerted on the palatal arch, the superelastic sections 4 and 5 are narrowed, for example, whereby they reach the martensite plateau. Under these conditions, the two molars 12 and 13 are subjected to correcting forces that simultaneously urge them in outward direction and exert a torque on them.

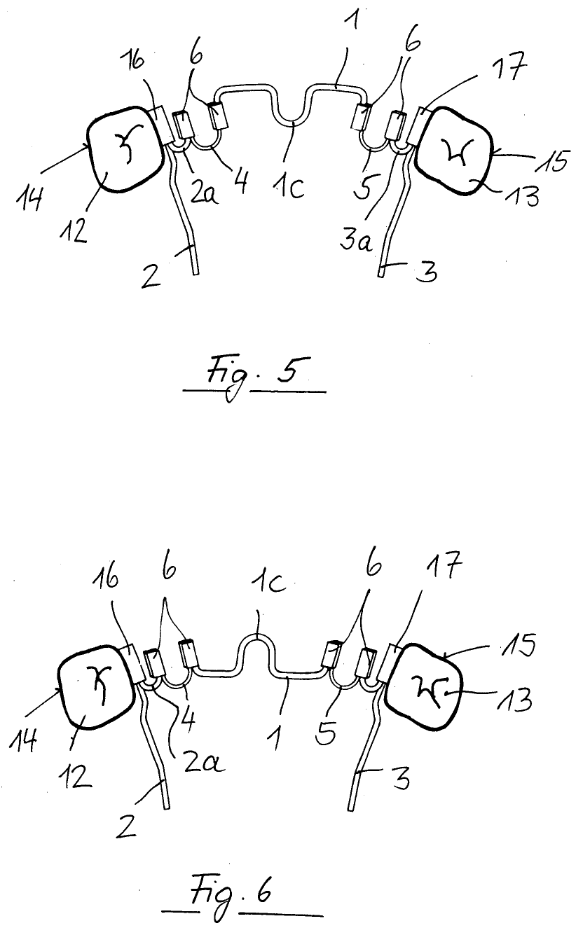

FIG. 5 shows a palatal arch similar to that of FIG. 1, in an installed condition similar to FIG. 4.

The palatal arch shown in FIG. 4 differs from the one of FIG. 1 only in that an activation loop 11 is provided in the central wire section 1 instead of a U-shaped activation bow.

The embodiment illustrated in FIG. 6 differs from the one of FIG. 5 in that the activation bow 1c opens toward the opposite direction. This results in a change of direction of the correcting force and of the torques connected therewith, that act on the molars 12 and 13. A different direction of the correcting force and of the torques can be achieved by the orthodontist also by deforming the normal-elastic sections 1, 2 and 3 in a different fashion.

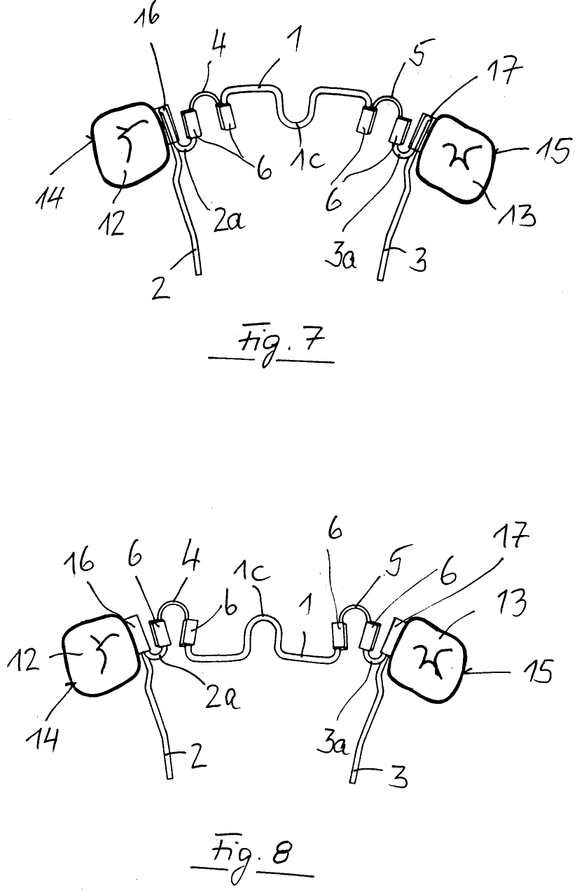

The embodiment illustrated in FIG. 7 differs from that shown in FIG. 6 in that the two superelastic intermediate sections 4 and 5 are configured as U-shaped bows oriented in the reverse sense compared with FIG. 6. This likewise allows the forces and torques to be given a different direction.

The embodiment illustrated in FIG. 8 differs from that shown in FIG. 5 in that the two superelastic intermediate sections 4 and 5 are configured as U-shaped bows oriented in the reverse sense compared with FIG. 6. This allows the forces and torques to be given a different direction.

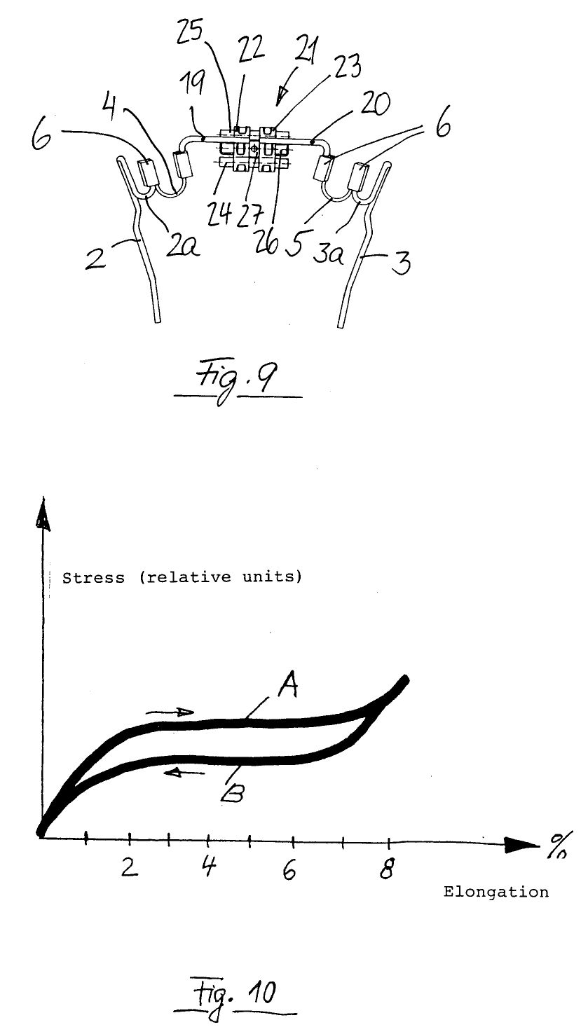

The embodiment illustrated in FIG. 9 differs from that shown in FIG. 4 in that its central section is divided into two separated sections 19 and 20 which are connected one with the other by an expansion screw 21. The expansion screw 21 takes the place of the activation bow 1c in FIG. 1. The expansion screw 21 comprises two bodies 22 and 23 which are connected and guided straight by two cylindrical guide bars 24 and 25. The guide bars 24 and 25 are passed through matching guide bores in the bodies 22 and 23. A double spindle 26, comprising an activation part 27 arranged between the bodies 22 and 23 and two threaded portions with oppositely directed threads extending therefrom, is arranged between the guide bars 24 and 25 and extends in parallel with respect to them. The threaded sections are engaged in matching threaded bores in the bodies 22 and 23. The relative spacing between the two bodies 22 and 23 can be varied by rotating the actuation section 27.

Fixed on the outside of the body 22 is section 19, fixed on the outside of the body 23 is section 20 of the central normal-elastic section of the palatal arch, the arrangement being such that the two sections 19 and 20 are aligned one with the other. The connection between the two bodies 22 and 23 can be produced by welding. The expansion screw 21, that does not comprise a spring in this embodiment, is conveniently made from stainless steel. By actuating the expansion screw 21 it is possible to tension or re-tension the superelastic intermediate sections 4 and 5, so as to activate or reactivate the palatal arch, and this even after the palatal arch has been fitted on the patient's dentition.

In any case, biasing of the superelastic wire sections 4, 5 occurs near the tooth 12, 13 or the molar lock 16,17, respectively. This is important because it has been found that when deforming a superelastic wire the latter, unlike a normal-elastic wire, will deform most strongly near the clamping point. But it is exactly that deformation which finally transmits the correcting moments to the tooth.

By connecting short wire sections made from a superelastic material the palatal arch according to the invention, therefore, actually permits constant forces to be exerted on the tooth when the palatal arch is activated. By locating the superelastic wire sections near the clamping point of the palatal arch it is ensured that constant torques are transmitted to the molars. Unlike known systems, the systems according to the invention actually succeed in transmitting to the teeth harmless physiological forces, which can be considered as being almost constant, as well as constant moments.

With the necessary adaptations, the palatal arch can be used also on the upper jaw, instead of the lower jaw.

FIG. 10 shows a typical tensile stress-strain curve for a superelastic nickel-titanium wire. When extending such a wire under tensile stress, one initially requires a moderately rising tensile force in order to progressively extend the wire. After an extension by approximately 2%, the tensile force required to achieve progressive extension will then rise only slightly until it starts again to rise more steeply after an extension of approximately 8% (upper branch A of the curve). When the wire is then released, the wire resumes its shape in the way illustrated by the lower branch B of the curve. This phenomenon shows a hysteresis characteristic. The flat portion of the characteristic, in the illustrated embodiment the portion between 2% and 8%, which is known as the martensite plateau, is utilised for the purposes of the invention.

1. A composite palatal arch for the correction of the position of teeth,
built up from a plurality of wire sections made from different materials, one of which materials is a shape-memory alloy that assumes a superelastic state at the temperatures prevailing in a human mouth,
and comprising two end sections, which are intended to fix the palatal arch in a tooth lock and which are made from of a normal-elastic material,
the section assuming a superelastic state being softer than the sections made from a normal-elastic material,
characterised in that the superelastic material is present only in two intermediate sections between the two end sections and a central section and that the two intermediate sections are each arranged adjacent one of the end sections,
and that the central section of the palatal arch consists of a normal-elastic material.

2. A composite palatal arch for the correction of the position of teeth,
built up from a plurality of wire sections made from different materials, one of which materials is a shape-memory alloy that assumes a superelastic state at the temperatures prevailing in a human mouth,
and comprising two end sections, which are intended to fix the palatal arch in a tooth lock and which are made from of a normal-elastic material,
the section assuming a superelastic state being softer than the sections made from a normal elastic material,
characterised in that the superelastic material is present only in a single intermediate section between one of the end sections and a central section and that said intermediate section is arranged adjacent the respective end section, and that the central section of the palatal arch consists of a normal-elastic material.

3. The palatal arch as defined in claim 1 or claim 2, in which the superelastic intermediate section is shorter than the normal-elastic central section.

4. The palatal arch as defined in claim 3, in which the two superelastic intermediate sections together are shorter than the normal-elastic central section.

5. The palatal arch as defined in claim 1 or 2, in which each superelastic section has a flexible length of 3 mm to 15 mm.

6. The palatal arch as defined in claim 1 or 2, in which the superelastic intermediate sections are configured as a shaped spring.

7. The palatal arch as defined in claim 6, in which the superelastic intermediate sections have the form of a U-shaped bow or comprise a U-shaped bow.

8. The palatal arch as defined in claim 6, in which the superelastic intermediate sections exhibit meander-shaped, S-shaped or zigzag-shaped form.

9. The palatal arch as defined in claim 1 or 2, in which its central wire section is configured as a shaped wire.

10. The palatal arch as defined in claim 9, in which its central wire section comprises at least one activation bow or one activation loop.

11. The palatal arch as defined in claim 9, in which its central wire section exhibits a meander-shaped, S-shaped or zigzag-shaped form.

12. The palatal arch as defined in claim 1 or 2, in which its normal-elastic wire sections are made from a stainless steel, especially a springy stainless steel.

13. The palatal arch as defined in claim 1 or 2, in which its different wire sections are connected one with the other by ferrules.

14. The palatal arch as defined in claim 1 or 2, in which the ends of the superelastic intermediate sections each carry a ferrule that is connected with the neighbouring normal-elastic wire section by welding or soldering.

15. The palatal arch as defined in claim 1 or 2, in which the shape-memory alloy is an alloy based on nickel and titanium containing nickel and titanium in approximately equal atomic percentages.

16. The palatal arch as defined in claim 1 or 2, in which the central wire section is divided into two sections that are connected one with the other by an expansion screw in order to permit their relative distance to be varied.

17. The palatal arch as defined in claim 16, in which the expansion screw is configured as a spring-operated expansion screw and comprises at least one spring that produces an expansion force.

18. The palatal arch as defined in claim 1 or 2, in which the central wire section is divided into two sections that are connected one with the other by an expansion appliance in order to permit their relative distance to be varied.

19. The palatal arch as defined in claim 18, in which the expansion appliance is configured as a spring-operated expansion appliance and comprises at least one spring that produces an expansion force.

20. The palatal arch as defined in claim 17 or claim 19, in which the at least one spring is superelastic.

21. The palatal arch as defenced in claim 1 or 2 in which each superelastic section has a flexible length of 5 mm to 12 mm.
